(19) United States
(12) Patent Application Publication
(10) Pub. No.: US 2024/0218157 A1
(43) Pub. Date: Jul. 4, 2024

(54) SCRATCH - RESISTANT POLYCARBONATE COMPOSITION

(71) Applicant: SABIC GLOBAL TECHNOLOGIES B.V., BERGEN OP ZOOM (NL)

(72) Inventors: Roshan Kumar Jha, Bangalore (IN); Arun Kumar Sikder, Bangalore (IN)

(21) Appl. No.: 18/288,240

(22) PCT Filed: Apr. 22, 2022
(86) PCT No.: PCT/EP2022/060699

§ 371 Date: Oct. 25, 2023

(30) Foreign Application Priority Data
May 3, 2021 (EP) 21171883.8

(51) Int. Cl. C08K 5/20; C08L 69/00

(52) U.S. Cl. CPC C08K 5/20; C08L 69/00; C08L 2203/30

(57) ABSTRACT

A thermoplastic composition contains 90.0 to 99.9 wt. % of aromatic polycarbonate; 0.1 to 5.0 wt. % of aliphatic amide wax having a melting point in the range from 80° C. to 115° C., and optionally, 0.01 to 5.0 wt. % of at least one additive.

### CROSS REFERENCE TO RELATED APPLICATIONS

This application is a National Stage application of PCT/EP2022/060699, filed Apr. 22, 2022, which claims the benefit of European Application No. 21171883.8, filed May 3, 2021, both of which are incorporated by reference in their entirety herein.

### BACKGROUND

The present invention relates to a thermoplastic composition comprising aromatic polycarbonate and an aliphatic amide wax. The present invention further relates to an article comprising or consisting of such a composition.

Polycarbonate is a well-known material and generally exhibits good mechanical and optical properties. Typical applications include optical media carriers, automotive glazing, OVAD (Outdoor Vehicle and Devices) exterior applications, extruded sheets, lenses and water bottles. Polycarbonate or polycarbonate based compositions may also be used for housing of electronic appliances, consumer electronic applications and the like.

Compositions comprising aromatic polycarbonate have excellent appearance, mechanical properties and dimensional stability, which are widely used in various fields. The popularity of such thermoplastic polymer compositions may be attributed to their balance of properties along with good melt flow characteristics (an important requirement for injection molding processes), combined with a competitive price. These compositions are particularly useful in fields such as interior and exterior parts in automobiles, housing of electronic devices etc.

However, as with many polymers, the scratch and abrasion resistance of conventional aromatic polycarbonate homopolymer may not be sufficient for certain applications. In view of this, alternative solutions have been established in the art for the provision of scratch-resistant surfaces of polymer articles. One solution was found in the use of poly(methyl methacrylate) (PMMA) as a base polymer of the respective articles due to its excellent scratch resistant properties. However, PMMA is not always a cost-effective solution and/or may not be a suitable alternative to polycarbonate for other reasons such as mechanical properties. A further alternative to the above-mentioned problem is to apply a scratch-resistant coating (e.g. a UV-curable coating) on the surface of the polymer article. This approach, however, is also less cost-effective and furthermore requires an additional processing step resulting in higher cycle time. Alternatively, use of additives have also been mentioned in prior art for various polymers that aid in improving the scratch resistance. The addition of certain inorganic or organic additives may improve the scratch and mar resistance of polycarbonate, but often times undesirably leads to a decrease in transparency and/or an increase in haze.

U.S. Pat. No. 5,731,376 discloses polypropylene block copolymer with improved scratch resistance by inclusion of a polyorganosiloxane. The compositions may further include a fatty acid amide.

U.S. Pat. No. 5,585,420 discloses scratch resistant polyolefin compositions comprising a plate like inorganic filler. The compositions may further comprise high rubber ethylene-propylene copolymers, fatty acid amides, polyorganosiloxanes or epoxy resins.

U.S. Pat. No. 7,462,670B2 describes a scratch resistant polymer substrate composition comprising Polycarbonate (PC), Acrylonitrile butadiene styrene (ABS) or PC/ABS blend, or ionomers and an additive combination. The additive combination mentioned is a carboxylic acid reagent functionalized olefin polymer.

JP 2019-131661 discloses a polycarbonate resin composition capable of manufacturing a high quality molded article with enhanced abrasion resistance while maintaining transparency and hydrophilicity of a surface, and a molded article consisting of the same. The polycarbonate resin composition contains a polycarbonate resin (A) and aliphatic acid amide (B). The polycarbonate resin (A) contains a constitutional unit derived from a dihydroxy compound represented by the following formula (1). The aliphatic acid amide (B) has an alkyl terminal with a functional group.

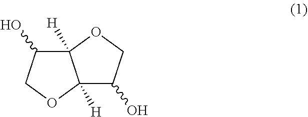

U.S. Pat. No. 5,554,302 discloses a composition comprising an aromatic carbonate polymer in admixture with a mold release effective amount of a compound of the formula

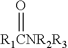

wherein R1, R2 and R3 are the same or different and are alkyl of one to twenty-five carbon atoms, inclusive with the proviso that the amide is essentially nonvolatizable under polymer processing conditions.

US 2020/0165430 discloses scratch-resistant thermoplastic polymer compositions (P) comprising 90 to 99.9 wt. % of at least one styrene-based copolymer, 0.1 to 10 wt. % of an aliphatic amide wax additive comprising at least one aliphatic amide wax composition having a melting point in the range of 80° C. to 115° C., and optionally at least one colorant, dye, pigment and/or further additive.

### SUMMARY

It is an object of the present invention to provide for a polycarbonate composition that has an improved resistance to scratch and/or mar.

More specifically, it is an object of the present invention to provide for a polycarbonate composition that has an improved resistance to scratch and/or mar, said composition having good optical properties such as transparency and haze.

The present inventors have surprisingly found that a composition comprising aromatic polycarbonate and a specific aliphatic amide wax demonstrates an improved scratch and mar resistant behavior compared to an otherwise identical composition that does not contain said aliphatic amide wax.

Without willing to be bound to it, the present inventors believe that the specific aliphatic amide wax acts as a scratch resistant agent that migrates to the surface, wherein it forms a thin lubricating layer, which in turn reduces the surface friction leading to improved resistance to scratch and mar.

Accordingly, the present invention relates to a thermoplastic composition comprising, based on the total weight of the composition, (A) from 90.0 to 99.9 wt. % of aromatic polycarbonate, (B) from 0.1 to 5.0 wt. % of aliphatic amide wax having a melting point in the range from 80° C. to 115° C., and optionally, (C) from 0.01 to 5.0 wt. % of at least one additive.

By application of the invention, the foregoing objects are met, at least in part.

### BRIEF DESCRIPTION OF THE DRAWINGS

FIG. 1 shows a typical cross-profile during the scratch experiment, wherein “A” refers to the scratch width, “B” refers to the total scratch depth, i.e. the indenter depth, “C” refers to the residual scratch depth and “D” refers to the scratch pile-up height.

FIG. 2 shows the total scratch depth (nm) of samples 1 to 8 after scratch experiments;

FIG. 3 shows the scratch width (um) of samples 1 to 8 after scratch experiments;

FIG. 4 shows the scratch pile up height (nm) of samples 1 to 8 after scratch experiments;

FIG. 5 shows % recovery of samples 1 to 8 after scratch experiments;

FIG. 6 shows the scratch visibility of samples 1 to 8 after scratch experiments;

FIG. 7A shows the change in % transmission before and after 500 cycles of mar testing of samples 1 to 8; and FIG. 7B shows the change in haze before and after 500 cycles of mar testing of samples 1 to 8.

### DETAILED DESCRIPTION

### Polycarbonate (Constituent A)

Polycarbonate is a well-known material and generally exhibits good mechanical and optical properties. Polycarbonates are generally manufactured using two different technologies. In a first technology, known as the interfacial technology or interfacial process, phosgene is reacted with bisphenol A (BPA) in a liquid phase. Another well-known technology for the manufacture of polycarbonate is the so-called melt technology, sometimes also referred to as melt transesterification or melt polycondensation technology. In the melt technology, or melt process, a bisphenol, typically BPA, is reacted with a carbonate, typically diphenyl carbonate (DPC), in the melt phase. A polycarbonate obtained by the melt transesterification process is known to be structurally different from polycarbonate obtained by the interfacial process. In that respect it is noted that in particular the so called “melt polycarbonate” typically has a minimum amount of Fries branching, which is generally absent in “interfacial polycarbonate”. Apart from that, melt polycarbonate typically has a higher number of phenolic hydroxy end groups while polycarbonate obtained by the interfacial process is typically end-capped and has at most 150 ppm, preferably at most 50 ppm, more preferably at most 10 ppm of phenol hydroxyl end-groups.

In accordance with the invention, it is preferred that the polycarbonate comprises or consists of aromatic bisphenol A polycarbonate homopolymer (also referred to herein as bisphenol A polycarbonate). Preferably, the polycarbonate of the invention disclosed herein comprises at least 60 wt. %, preferably at least 90 wt. % of bisphenol A polycarbonate based on the total amount of polycarbonate. More preferably, the polycarbonate in the composition essentially comprises or consists of bisphenol A polycarbonate. The aromatic polycarbonate in accordance with the invention preferably does not comprise a copolymer, such as for example polycarbonate-polysiloxane copolymers or polycarbonate-polyester copolymers. It is further preferred that apart from aromatic polycarbonate the composition as disclosed herein does not comprise non-aromatic polycarbonate.

In an aspect, the polycarbonate is an interfacial polycarbonate. In another aspect, the polycarbonate is a melt polycarbonate. In yet another aspect the polycarbonate is a mixture of from 20-80 wt. % of interfacial polycarbonate and from 80-20 wt. % of melt polycarbonate. The polycarbonate may be a mixture of two or more otherwise identical polycarbonates differing in molecular weight.

It is preferred that the polycarbonate has a weight average molecular weight of 15,000 to 60,000 g/mol determined using gel permeation chromatography with polycarbonate standards.

The present invention can also be extended to a molding composition comprising the thermoplastic composition and at least one further polymer component. The further polymer component may be one or more of acrylonitrile/butadiene/styrene copolymer (ABS), methyl methacrylate/butadiene/styrene copolymer (MBS), styrene/butadiene/styrene copolymer (SBS), styrene/acrylonitrile copolymer (SAN), acrylonitrile/styrene/acrylonitrile copolymer (ASA), polybutylene terephthalate (PBT), polyethylene terephthalate (PET), unsaturated polyester (UPES), polyamide (PA), thermoplastic urethane (TPU), polystyrene (PS), high impact polystyrene (HIPS), polyvinyl chloride (PVC).

The molding composition comprises from 99-50 wt. %, preferably 90-60 wt. % of the thermoplastic composition and from 1-50 wt. %, preferably from 10-40 wt. % of the one or more further polymer(s), based on the weight of the molding composition. It is preferred that the amount of thermoplastic composition in the molding composition is at least 60 wt. %, more preferably at least 70 wt. %, even more preferably at least 80 wt. % or at least 90 wt. % based on the weight of the molding composition. The amount of further polymer component may be at most 40 wt. %, preferably at most 30 wt. %, even more preferably at most 20 wt. % or at most 10 wt. % based on the weight of the molding composition. The molding composition may comprise from 99-90 wt. % of thermoplastic composition and from 10-1 wt. % of further polymer component, based on the weight of the molding composition.

In the context of the present invention it is preferred that the amount of thermoplastic composition is relatively high in that the amount of thermoplastic composition in the molding composition is at least 60 wt. % or at least 70 wt. % based on the weight of the molding composition.

The skilled person will understand that the molding composition may comprise conventional colorants, additives and/or fillers, which may be present in an amount of from 0.1-20 wt. %, prefer based on the weight of the molding composition. Colorants may be comprised in the molding composition in low amounts such as from 10-10000 ppm.

### Aliphatic Amide Wax (Constituent B)

The thermoplastic composition comprises 0.1 to 5.0 wt.-%, based on the total weight of the thermoplastic composition, of aliphatic amide wax. Preferably, the thermoplastic composition comprises 0.2-3.0 wt. %, more preferably 0.5-2.0 wt. % of the aliphatic amide wax (B). The aliphatic amide wax (B) has a melting point in the range from 80° C. to 115° C., preferably from 90° C. to 110° C., and most preferably from 100° C. to 108° C. The melting point of the aliphatic amide wax is determined in accordance with ASTM D127-19 (drop melting point method). Preferably the aliphatic amide wax comprises or consists of a primary or more preferably a secondary aliphatic amide wax. More preferably the aliphatic amide wax comprises or consists of amide compounds having the formula R1-CONH—R2, wherein R1 and R2 are each independently selected from aliphatic, saturated or unsaturated hydrocarbon groups having 1 to 30 carbon atoms, preferably 12 to 24 carbon atoms, in particular 16 to 20 carbon atoms.

In a particular preferred embodiment, the aliphatic amide wax comprises or consists of at least one amide compound derived from stearic acid, i.e. at least one amide compound wherein R1 represents an aliphatic, saturated hydrocarbon group having 17 carbon atoms. In this case, R2 preferably represents an aliphatic, saturated hydrocarbon group having 16 to 20 carbon atoms.

The aliphatic amide wax does not comprise or consist of N-methyl stearamide and/or stearamide.

It is preferred that the aliphatic amide wax is not a compound of the formula

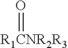

wherein R1, R2 and R3 are the same or different and are alkyl of one to twenty-five carbon atoms.

### Other Additives

The thermoplastic composition may optionally further comprise 0.01 to 5.0 wt.-% of at least one additive, preferably from 0.1 to 2.0 wt. %. Typical additives that are used in the composition can comprise one or more of dyes, pigments, antioxidants, stabilizers or colorants.

Examples additives may also include one or more of a flow modifier, filler, reinforcing agent (e.g., glass fibers or glass flakes), plasticizer, lubricant, release agent(in particular glycerol monostearate, pentaerythritol tetra stearate, glycerol tristearate, stearyl stearate), antistatic agent, antifog agent, antimicrobial agent, colorant (e.g., a dye or pigment), flame retardant that is either used alone or combined with an anti-drip agent such as polytetrafluoroethylene (PTFE) or PTFE encapsulated styrene-acrylonitrile copolymer, also known as TSAN.

These additives may be admixed at any stage of the manufacturing operation, but preferably at an early stage in order to profit early on from the stabilizing effects (or other specific effects) of the added substance.

Shaped, formed, or molded articles comprising the compositions are also provided. The compositions can be molded into articles by a variety of methods, such as injection molding, compression molding, blow molding, extrusion, and thermoforming. Some example of articles include automotive and vehicular body panels such as bumper covers and bumpers or a housing for electrical equipment. In a particular application the present invention relates to a sheet having a thickness of from 0.1-6mm, preferably from 2-5 mm and wherein said sheet consists of the thermoplastic composition disclosed herein. Such a sheet may be used in applications where scratch resistance is an important property. For example such sheets may be used in (automotive) glazing applications or in touch panel applications.

In another application, the thermoplastic composition may be used to manufacture an article of furniture such as a stool, chair, a couch or a table.

Accordingly, the present invention relates to an article comprising or consisting of the composition disclosed herein. More in particular, the present invention relates to vehicular body parts or for housing of electrical equipment comprising or consisting of the composition disclosed herein. Likewise, the present invention relates to a vehicle or an electrical equipment comprising said vehicular body part or said housing. The present invention relates to the use of the composition disclosed herein for the manufacture of an article, such as an automotive part.

### Composition

In accordance with the invention the thermoplastic composition comprises, based on the total weight of the composition, (A) from 90.0 to 99.9 wt. % of aromatic polycarbonate, (B) from 0.1 to 5.0 wt. % of aliphatic amide wax having a melting point in the range from 80° C. to 115° C., and (C) optionally from 0.01 to 5.0 wt. % of at least one additive.

The amount of aromatic polycarbonate is preferably from 95.0 wt. %-99.8 wt. % and the amount of aliphatic amide wax is preferably from 0.2-3.0 wt. %, more preferably from 0.2-2.0 wt. %, even more preferably from 0.5-1.7 wt. %.

It is preferred that the aliphatic amide wax comprises or consists of amide compounds having the formula R1-CONH—R2, wherein R1 and R2 are each independently selected from aliphatic, saturated or unsaturated hydrocarbon groups having 16 to 20 carbon atoms.

For the avoidance of doubt, the skilled person will understand that the total weight of the thermoplastic composition will represent 100 wt. % and that any combination of materials which would not form 100 wt. % in total is unrealistic and not according to the invention. Thus, the total of the components making up the thermoplastic composition disclosed herein is 100 wt. %.

In an aspect the present invention further relates to the use of an aliphatic amide wax as disclosed herein and having a melting point in the range from 80° C. to 115° C. as determined in accordance with ASTM D127-19, in a thermoplastic composition comprising, based on the weight of the thermoplastic composition, (A) from 90.0 to 99.9 wt. % of aromatic polycarbonate, (B) from 0.1 to 5.0 wt. % of said aliphatic amide wax, and (C) optionally from 0.01 to 5.0 wt. % of at least one additive or consisting of aromatic polycarbonate for improving the scratch resistance.

### Properties

It was surprisingly found that addition of the aliphatic amide wax as described above to the thermoplastic composition comprising aromatic polycarbonate homopolymer, leads to favorable scratch and mar resistant properties, while maintaining transparency and lower haze.

Accordingly the present invention also relates to the use of the aliphatic amide wax having a melting point in the range from 80° C. to 115° C., in a thermoplastic composition comprising or consisting of aromatic polycarbonate for improving the scratch resistance.

In accordance with the invention, the thermoplastic composition as disclosed herein has an indenter depth of less than 0.3 μm at 48 mN profile load and ≥50% recovery of scratch, as determined by the Nano scratch Test, as described below:

### Nano-Scratch Test

A Nano-Indenter® XP (KLA Corporation, Milpitas, USA) was used to perform nano-scratch test on the test specimens. In this nano-indenter, the maximum distance allowed for the tip to travel, normal to the sample surface, was about 1.5 mm. Over this entire range, the displacement resolution was better than 0.1 nm. The maximum load capacity for this system was 500 mN with a precision of better than 1 μN. In a typical nano-scratch experiment, the indenter was dragged along the surface with a load-ramping mode. A three-sided Berkovich-shaped diamond indenter was used to perform scratch testing in a face forward mode. A typical scratch experiment was performed in four stages (V. Jardret, P. Morel, “Viscoelastic effects on the scratch resistance of polymers: relationship between mechanical properties and scratch properties at various temperatures”, Prog. Org. Coat., 48, 322, (2003)); an original profile, a scratch segment, a residual profile and a cross profile.

In the original profile, surface morphology was obtained by pre-profiling the surface with 50 mN load at a predetermined location where the scratch was to be performed. Then indenter came back to its initial location and scratch experiment started with increasing normal load from 50 mN to 120 mN. A post scratch profile was performed along the same path with 50 mN load to measure the residual deformation in the groove. Finally a cross profile was performed at a predetermined location (at 48 mN profile load for this experiment) to evaluate the deformation. Optimization of test parameters is discussed in the next section. On each of the sample, five scratches were performed and parameters were reported after taking average of these tests. Test parameters used in this study are shown in the Table 1.

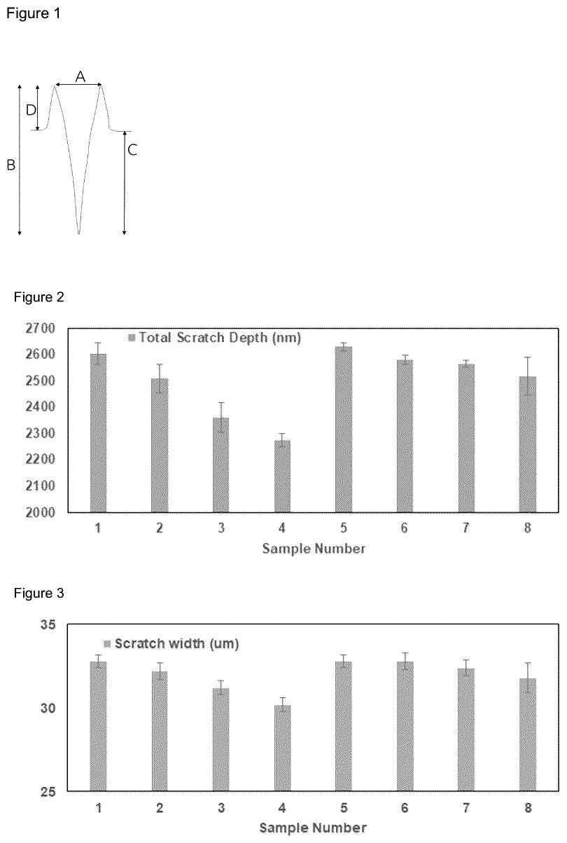

FIG. 1 shows a typical cross-profile during the scratch experiment, wherein “A” refers to the scratch width, “B” refers to the total scratch depth, i.e. the indenter depth, “C” refers to the residual scratch depth and “D” refers to the scratch pile-up height.

TABLE 1
Optimized scratch parameters for performing nano-scratch testing.

| | | |
|---|---|---|
| Maximum Load | 120 | mN |
| Profile at | 48 | mN |
| Scratch velocity | 10 | μm/s |
| Scratch Length | 500 | μm |
| Profile Load | 50 | μN |

| | |
|---|---|
| Tip | Berkovich (Face front, ~0.05 μm diameter) |

Further, the thermoplastic composition as disclosed herein has a delta haze of ≤4 and a transmittance of at least 90%, after 500 cycles of Crockmeter Mar test as described below:

### Crockmeter Mar Test:

Crockmeter Mar test was performed on molded samples using automated Crockmeter (Globetex Industries, India). For this, a 9N force was constantly applied to the protruding 16 mm acrylic finger, which is covered with an abrading fabric held in place with a metal ring. A 50 mm×50 mm piece of felt (Test Fabric Inc.) was placed between the acrylic finger and the abrading fabric (Linen L-61U from Test Fabric Inc.). The arm was stroked over the sample at length of 50 mm.

The haze and transmittance of the samples were measured before and after the mar testing in order to calculate delta transmission and delta haze. Haze-gard plus from BYK Gardner (BYK Gardner GmbH, Germany) was used for measurement of haze and transmission (ASTM D1003 standard). The specimen size is 60 mm×60 mm square chip of 3 mm thickness.

The delta haze is given by the following equation:

delta haze=|% haze after mar test−% haze before mar test|

The delta transmission is given by the following equation:

delta transmission=|% transmission after mar test−% transmission before mar test|

The present invention will now be further elucidated based on the following non-limiting examples.

### EXAMPLES

Thermoplastic compositions were made by extruding on a Werner Pfleiderer 25 millimeter (mm) co-rotating intermeshing twin-screw extruder having L/D of 41. The components of the compositions and their sources are listed in Table 2. All components were dry-mixed and added to the throat of the extruder. The extruder was set with barrel temperatures between 150° C. and 260° C. The material was run maintaining torque of 55-60% with a vacuum of 100 millibar (mbar)—800 mbar applied to the melt during compounding. The composition was pelletized after exiting the die head.

All samples were molded via injection molding with the molding machine set from 40-280° C. and mold set at 100° C.

TABLE 2
Components of the compositions and their source

| | |
|---|---|
| PC1 | Bisphenol A polycarbonate manufactured using an interfacial |
| | process, having a melt volume rate of 6 cc/10 min, available |
| | from SABIC (PC 105) |
| Add1 | Aliphatic amide wax derived from stearic acid having a melting |
| | point of 102-106° C., and a density of 0.87 g/cm3 (commercially |
| | available IncroMax ® PS from Croda International, UK). |
| Add2 | IncroMax ® 300 from Croda International, UK having a melting |
| | point of −33° C. |
| Add3 | Atmer ® 7650 (50% concentrate of IncroMax ® 300) from Croda |
| | International, UK. |
| Stab | Stabilizer - hindered phenol Antioxidant Irganox 1010 from BASF |

TABLE 3
Formulations and corresponding physical and scratch properties
of thermoplastic PC composition according to the invention

| | Example | | | | | | | |
|---|---|---|---|---|---|---|---|---|
| | CE1 | Ex1 | Ex2 | Ex3 | CE2 | CE3 | CE4 | CE5 |
| Sample No. | 1 | 2 | 3 | 4 | 5 | 6 | 7 | 8 |
| PC1 | 99.9 | 99.4 | 98.9 | 97.9 | 99.4 | 98.9 | 99.4 | 98.9 |
| Add1 | | 0.5 | 1 | 2 | | | | |
| Add2 | | | | | 0.5 | 1 | | |
| Add3 | | | | | | | 0.5 | 1 |
| Stab | 0.1 | 0.1 | 0.1 | 0.1 | 0.1 | 0.1 | 0.1 | 0.1 |
| Transmittance, % | 90.7 | 90.5 | 90.7 | 90 | 90.9 | 90.6 | 90.8 | 90.9 |
| Haze | 0.7 | 1.1 | 1.3 | 1.7 | 0.7 | 0.7 | 0.7 | 0.6 |
| Residual Scratch depth | 1818 | 1769 | 1645 | 1597 | 1819 | 1785 | 1820 | 1720 |
| (nm) | | | | | | | | |
| Scratch pile up height | 785 | 740 | 717 | 679 | 811 | 797 | 745 | 799 |
| (nm) | | | | | | | | |
| % Recovery | 54 | 55 | 61 | 61 | 54 | 55 | 55 | 53 |
| Total Scratch Depth | 2603 | 2509 | 2362 | 2276 | 2630 | 2582 | 2565 | 2519 |
| (nm) | | | | | | | | |
| Scratch width (um) | 32.8 | 32.2 | 31.2 | 30.2 | 32.8 | 32.8 | 32.4 | 31.8 |

The amounts in Table 3 are in weight percent based on the total weight of the 10 composition. In all the examples, the total amount of components, equals 100 weight percent. Table 3 shows that Thermoplastic compositions according to the invention show improved scratch resistance properties (Residual Scratch depth, Scratch pile up height, % Recovery, Total Scratch Depth and Scratch width) compared to an otherwise identical composition not comprising the aliphatic amide wax in accordance with the invention.

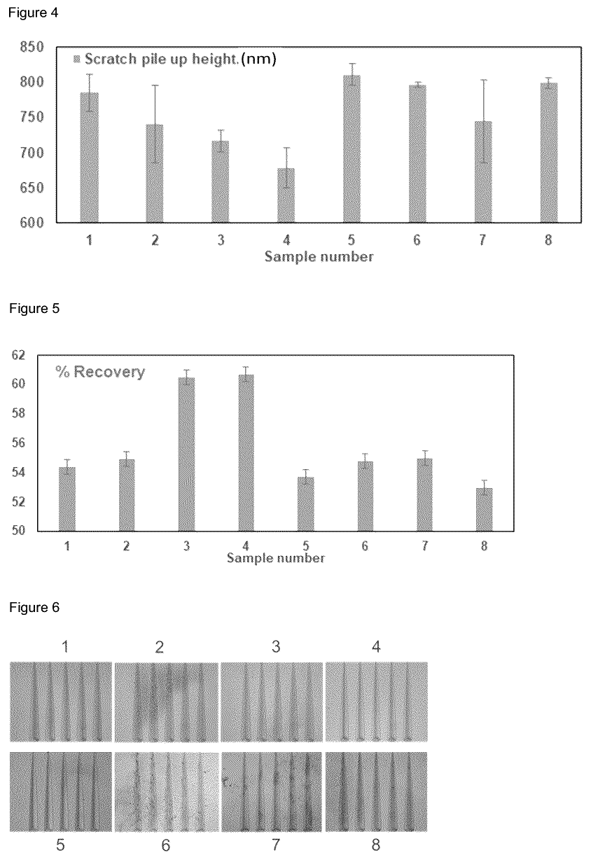

Scratch performance results are also summarized in Table 3 and in FIGS. 2-5. Sample 1 is the Comparative example (CE1) without the scratch resistant additive and Sample 2-7 are the subsequent examples in presence of different scratch resistant additives.

Lower the depth and width of scratch and higher the % recovery of scratch, better is the scratch performance of the composition.

Sample 3, and 4 (composition comprising aliphatic amide wax) showed better scratch performance. In addition, the scratch % recovery improves significantly for compositions having the aliphatic amide wax compared to virgin aromatic polycarbonate (Sample 1). Usually higher the recovery, better the scratch performance. Indenter depth and scratch pile up height are also lower with the aliphatic amide waxes. Lower pile up height helps to reduce the scratch visibility as evident from FIG. 6.

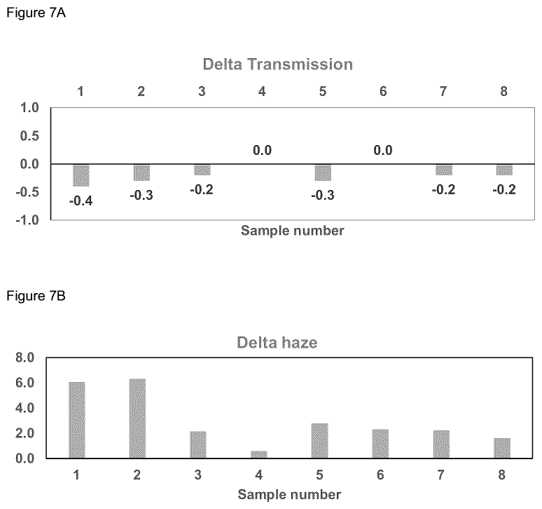

FIG. 7 shows the change in % transmission and haze before and after 500 cycles of mar testing as described in the testing methods. No significant change was observed in the transmission observed after marring. Almost six times better delta haze was observed for the samples containing the aliphatic amide wax (FIG. 6). Mar performance was also improved along with scratch performance in such compositions. FIG. 7: Delta % Transmission and delta haze after 500 cycles mar testing with Crockmeter using linen as marring element as described above.

In certain applications, like glazing in automotive and appliances' touch panels the transparency and haze is an important feature that should be retained while improving scratch performance. It is apparent from the above results that aromatic polycarbonate compositions comprising aliphatic amide wax show improved scratch and mar performance without compromising the transparency and haze.
**********

1. A thermoplastic composition comprising, based on the weight of the composition,
(A) from 90.0 to 99.9 wt.% of aromatic polycarbonate, and
(B) from 0.1 to 5.0 wt.% of aliphatic amide wax having a melting point in the range from 80° C. to 115° C. as determined in accordance with ASTM D127-19.

2. The thermoplastic composition according to claim 1, wherein the aliphatic amide wax comprises or consists of amide compounds having the formula R1-CONH—R2, wherein R1 and R2 are each independently selected from aliphatic, saturated or unsaturated hydrocarbon groups having 1 to 30, preferably 16 to 20 carbon atoms.

3. The thermoplastic composition of claim 1, wherein the amount aliphatic amide wax is from 0.2-3.0 wt. %.

4. The thermoplastic composition of claim 1, wherein the aromatic polycarbonate comprises or consists of bisphenol-A polycarbonate homopolymer.

5. The thermoplastic composition of claim 1, wherein the thermoplastic composition has an indenter depth of less than 0.3 μm at 48 mN profile load and ≥50% recovery of scratch, as determined by the Nano scratch Test as described in the specification.

6. The thermoplastic composition of claim 1, wherein said aliphatic amide wax does not comprise or consist of N-methyl stearamide and/or stearamide.

7. The thermoplastic composition of claim 1, wherein the thermoplastic composition has a delta haze of ≤4 and a transmittance, determined in accordance with the method set out in the description, of at least 90%, after 500 cycles of Crockmeter Mar test, determined in accordance with the method set out in the description, wherein delta haze is given by the following equation:
delta haze=|% haze after mar test−% haze before mar test|.

8. A molding composition comprising the thermoplastic composition of claim 1 and at least one further polymer component, wherein the amount of thermoplastic composition in the molding composition is at least 60 wt. % based on the weight of the molding composition.

9. An article comprising or consisting of the thermoplastic composition of claim 1 or the molding composition of claim 8.

10. (canceled)

11. (canceled)

12. (canceled)

13. The thermoplastic composition of claim 1 further comprising, based on the weight of the composition:
(C) from 0.01 to 5.0 wt. % of at least one additive.

14. The thermoplastic composition of claim 2, wherein R1 and R2 are each independently selected from aliphatic, saturated or unsaturated hydrocarbon groups having 16 to 20 carbon atoms.

15. The thermoplastic composition according to claim 3, wherein the amount aliphatic amide wax is from 0.5-2.0 wt. %.

16. The molding composition according to claim 8, wherein the amount of thermoplastic composition in the molding composition is at least 70 wt. % based on the weight of the molding composition.

17. The molding composition according to claim 8, wherein the amount of thermoplastic composition in the molding composition is at least 80 wt. % based on the weight of the molding composition.

18. The article according to claim 8 being a vehicular body part or a housing for electrical equipment.
